(19) United States
(12) Patent Application Publication
(10) Pub. No.: US 2023/0158835 A1
(43) Pub. Date: May 25, 2023

(54) TIRE AND BELT LAYER

(71) Applicant: Sumitomo Rubber Industries, Ltd., Hyogo (JP)

(72) Inventors: Dong MIAO, Kobe-shi (JP); Masumi SUZUKI, Kobe-shi (JP)

(73) Assignee: Sumitomo Rubber Industries, Ltd., Hyogo (JP)

(21) Appl. No.: 17/756,707

(22) PCT Filed: Oct. 26, 2020
(86) PCT No.: PCT/JP2020/040070

§ 371 Date: May 31, 2022

(30) Foreign Application Priority Data
Dec. 25, 2019 (JP) 2019-234856

(51) Int. Cl. B60C 9/20; B60C 9/00; D07B 1/06

(52) U.S. Cl. CPC B60C 9/2006; B60C 9/0007; D07B 1/0606; B60C 2009/2012; B60C 2009/2064; B60C 2009/2077; D07B 2201/2003; D07B 2201/2009; D07B 2205/3025; D07B 2501/2046

(57) ABSTRACT

A tire includes a belt layer in a tread portion. The belt layer includes at least one belt ply. The belt ply includes a plurality of belt cords including a steel single wire having a flat cross-sectional shape. In at least one of the belt cords, the steel single wire has a short diameter direction inclined at an angle θ of less than 90 degrees with respect to a thickness direction of the belt ply.

### FIELD OF THE INVENTION

The present invention relates to a tire provided with a belt layer in a tread portion and the belt layer thereof.

### BACKGROUND OF THE INVENTION

Conventionally, tires using belt cords made of steel single wires each having a flat cross-sectional shape in the belt layer have been known. For example, Patent Document 1 below has proposed a pneumatic tire that maintains good durability against belt breakage by embedding a belt layer with an array of single-wire steel wires having a flat cross-sectional shape.

### Prior Art Document

### Patent Document

### Patent Document 1

Japanese Unexamined Patent Application Publication No. 2018-058515

### SUMMARY OF THE INVENTION

### Problems to Be Solved By the Invention

However, the distance between the single-wire steel wires in the pneumatic tire of Patent Document 1 is small, and cracks generated in the area can grow and damage the belt layer, therefore, there has been a demand for further improvement in durability performance.

The present invention has been made in view of the above, and a primary object thereof is to provide a tire provided with a belt layer capable of improving steering stability performance, ride comfort performance, and the durability performance in a good balance and to provide the belt layer thereof.

### Means for Solving the Problems

The present invention is a tire including a tread portion and a belt layer disposed in the tread portion, wherein the belt layer includes at least one belt ply, the belt ply includes a plurality of belt cords including a steel single wire having a flat cross-sectional shape, and in at least one of the belt cords, the steel single wire has a short diameter direction inclined at an angle of less than 90 degrees with respect to a thickness direction of the belt ply.

In the present invention, it is preferred that the belt cords are inclined at an angle of 5 to 45 degrees.

In the present invention, it is preferred that the belt cords are inclined at an angle of 10 to 35 degrees.

In the present invention, it is preferred that the steel single wire has a short diameter (SD) of 0.15 to 0.42 mm in the cross-sectional shape.

In the present invention, it is preferred that the steel single wire has a ratio (SD/LD) of 0.70 or less between a short diameter (SD) and a long diameter (LD) in the cross-sectional shape.

In the present invention, it is preferred that the steel single wire has a ratio (SD/LD) of 0.50 or more between a short diameter (SD) and a long diameter (LD) in the cross-sectional shape.

In the present invention, it is preferred that the belt cords include a first belt cord having the steel single wire having the short diameter direction inclined to a first side with respect to the thickness direction of the belt ply and a second belt cord having the steel single wire having the short diameter direction inclined to a second side opposite to the first side with respect to the thickness direction of the belt ply.

In the present invention, it is preferred that the steel single wire of the first belt cord and the steel single wire of the second belt cord are inclined at the same angle to opposite sides to each other.

In the present invention, it is preferred that the belt cords further include a third belt cord having the steel single wire having the short diameter direction oriented along the thickness direction of the belt ply.

In the present invention, it is preferred that five belt cords adjacent in the tire axial direction include at least one first belt cord and at least one second belt cord.

In the present invention, it is preferred that the belt ply includes a topping rubber covering the belt cords, and the topping rubber has a complex elastic modulus (E*) at 70° C. of 7 to 20 MPa.

The present invention is a belt layer disposed in a tread portion including at least one belt ply, wherein the belt ply includes a plurality of belt cords including a steel single wire having a flat cross-sectional shape, and in at least one of the belt cords, the steel single wire has a short diameter direction inclined at an angle of less than 90 degrees with respect to a thickness direction of the belt ply.

### Effects of the Invention

In the tire of the present invention, the belt ply includes a plurality of the belt cords including the steel single wire having the flat cross-sectional shape, and in at least one of the belt cords, the steel single wire has the short diameter direction inclined at the angle of less than 90 degrees with respect to the thickness direction of the belt ply.

It is possible that the belt ply configured as such increases the distance between the steel single wires, therefore, stress in the portion is relieved, thereby, the occurrence of cracks in the portion is suppressed, therefore, it is possible that the durability performance is improved. Thereby, it is possible that the tire of the present invention improves the steering stability performance, the ride comfort performance, and the durability performance in a good balance.

In the belt layer of the present invention, the belt ply includes a plurality of the belt cords including the steel single wire having the flat cross-sectional shape, and in at least one of the belt cords, the steel single wire has the short diameter direction inclined at the angle of less than 90 degrees with respect to the thickness direction of the belt ply.

It is possible that the belt ply configured as such increases the distance between the steel single wires, therefore, stress in the portion is relieved, thereby, the occurrence of cracks in the portion is suppressed, therefore, it is possible that the durability performance is improved. Thereby, it is possible that the belt layer of the present invention improves the steering stability performance, the ride comfort performance, and the durability performance in a good balance.

### BRIEF DESCRIPTION OF THE DRAWINGS

FIG. 1 is a cross-sectional view showing a tire according to an embodiment of the present invention.

FIG. 2 is a cross-sectional view of a belt ply.

FIG. 3 is a cross-sectional view of the belt ply according to another embodiment of the present invention.

### DETAILED DESCRIPTION OF THE INVENTION

An embodiment of the present invention will now be described in conjunction with accompanying drawings.

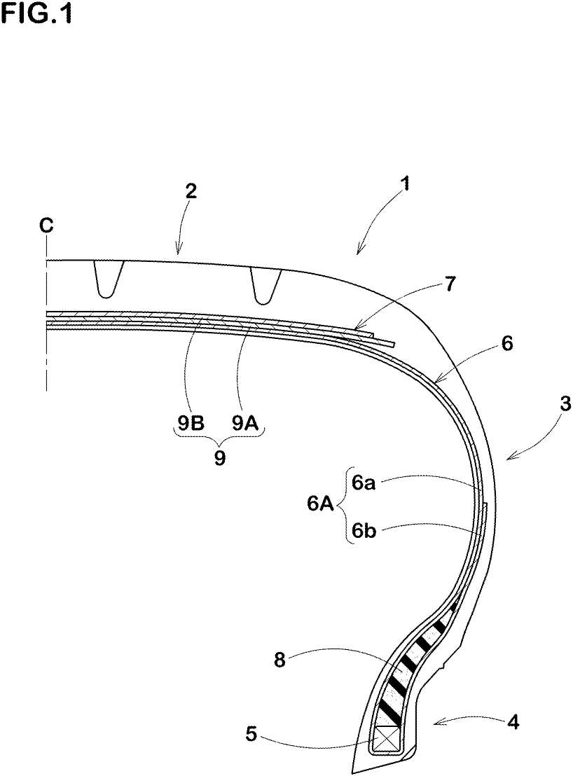

FIG. 1 is a tire meridian section of a tire 1 passing through a rotational axis of the tire 1 in a standard state. The tire 1 of the present embodiment is suitable for use as a rubber pneumatic tire to be mounted on passenger cars and the like. It should be noted that the tire 1 is not limited to rubber pneumatic tires for passenger cars, but can be applied to a variety of tires, such as heavy-duty pneumatic tires, plastic pneumatic tires, and non-pneumatic tires not filled with pressurized air therein, for example.

Here, in the case where the tire 1 is a rubber pneumatic tire, the “standard state” is a state in which the tire 1 is mounted on a standard rim, inflated to a standard inner pressure, and loaded with no tire load. In the following, unless otherwise mentioned, the dimensions of various parts of the tire 1 are the values measured in this standard state.

The “standard rim” is a wheel rim specified for the concerned tire by a standard included in a standardization system on which the tire is based, for example, the “normal wheel rim” in JATMA, “Design Rim” in TRA, and “Measuring Rim” in ETRTO.

The “standard inner pressure” is air pressure specified for the concerned tire by a standard included in a standardization system on which the tire is based, for example, the maximum air pressure in JATMA, maximum value listed in the “TIRE LOAD LIMITS AT VARIOUS COLD INFLATION PRESSURES” table in TRA, and “INFLATION PRESSURE” in ETRTO.

As shown in FIG. 1, the tire 1 of the present embodiment includes a tread portion 2 extending annularly, a pair of sidewall portions 3 extending on both sides of the tread portion 2, and a pair of bead portions 4 extending in connection with the sidewall portions 3. The tire 1 of the present embodiment has a toroidal carcass 6 extending between bead cores 5 of the pair of the bead portions 4, and a belt layer 7 arranged radially outside the carcass 6 and inside the tread portion 2.

The carcass 6 includes at least one carcass ply, in the present embodiment one carcass ply 6A. The carcass ply 6A includes carcass cords (not shown) arranged at an angle of 75 to 90 degrees with respect to a tire circumferential direction, for example. Organic fiber cords such as aromatic polyamide or rayon and the like can be employed as the carcass cords, for example.

The carcass ply 6A includes a main body portion (6a) extending between the pair of the bead cores 5, and turned-up portions (6b) connected to the main body portion (6a) and each turned up from the inside to the outside in a tire axial direction around a respective one of the bead cores 5, for example. A bead apex rubber 8 extending outward in a tire radial direction from each of the bead cores 5 is disposed between the main body portion (6a) and each of the turned-up portions (6b) of the carcass ply 6A, for example.

The belt layer 7 includes at least one belt ply, in the present embodiment two belt plies 9. The two belt plies 9 include a first belt ply 9A arranged radially inside and a second belt ply 9B arranged radially outside the first belt ply 9A, for example. The belt layer 7 configured a such increases rigidity of the tread portion 2, therefore, it is possible that the durability performance of the tire 1 is improved.

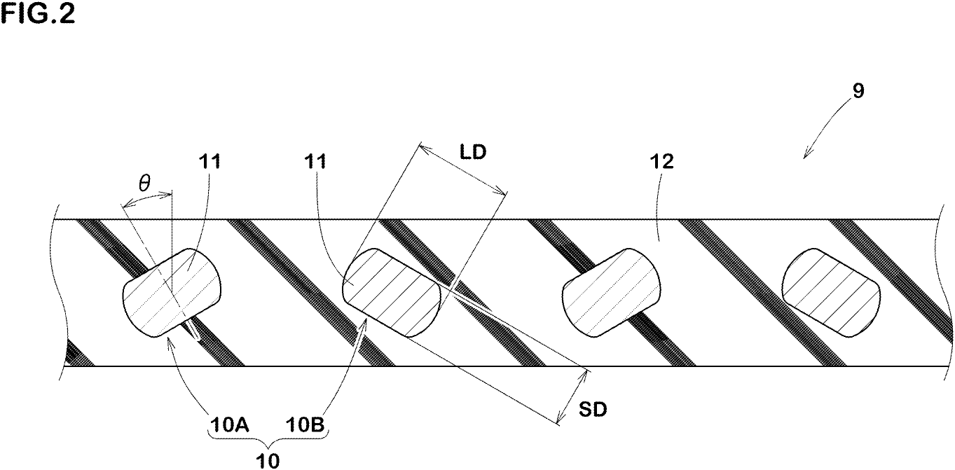

FIG. 2 is an enlarged cross-sectional view of the belt plies 9. As shown in FIG. 2, at least one of the belt plies 9 of the present embodiment includes a plurality of belt cords 10 including steel single wires 11 having a flat cross-sectional shape and a topping rubber 12 covering the belt cords 10. The belt cords 10 configured as such can improve the strength of belt layer 7 without excessively increasing the rigidity thereof, therefore, it is possible that both the steering stability performance and the ride comfort performance of the tire 1 are achieved.

In at least one of the belt cords 10 of the present embodiment, a short diameter direction of the steel single wire 11 is inclined at an angle θ of less than 90 degrees with respect to a thickness direction of the belt ply 9. The belt plies 9 configured as such can increase the distance between the steel single wires 11, therefore, stress in the area is relieved, thereby, the occurrence of delamination originating from edges of the belt plies 9 is suppressed, therefore, it is possible that the durability performance of the tire 1 is improved. Thereby, it is possible that the tire 1 of the present embodiment improves the steering stability performance, the ride comfort performance, and the durability performance in a good balance.

From such a point of view, the angle θ of the belt cords 10 is more preferably in the range of 5 to 45 degrees, and even more preferably in the range of 10 to 35 degrees. Each of the belt cords 10 is inclined at the same angle θ, for example. The angle θ of the belt cords 10 may be different for each of the steel single wires 11.

When the angle θ of the belt cords 10 is different for each of the steel single wires 11, it is preferred that the average value of the angles θ of the steel single wires 11 is within the above ranges, and it is more preferred that the angle θ of each of the steel single wires 11 is within the above ranges. It is possible that the belt plies 9 containing the steel single wires 11 configured as such significantly improve the durability performance of the tire 1 while good steering stability performance and good ride comfort performance of tire 1 are maintained.

It is preferred that each of the steel single wires 11 has a short diameter SD in the cross-sectional shape of 0.15 to 0.42 mm. Since the short diameter SD of each of the steel single wires 11 is 0.15 mm or more, the strength of the steel single wires 11 is maintained, therefore, it is possible that the durability performance of the tire 1 is improved. Since the short diameter SD of each of the steel single wires 11 is 0.42 mm or less, excessive increase in the rigidity of the belt layer 7 is suppressed, therefore, it is possible that the ride comfort performance is improved.

In the cross-sectional shape of each of the steel single wires 11, it is preferred that a ratio (SD/LD) of the short diameter SD and a long diameter LD is 0.70 or less. Since the ratio (SD/LD) of the steel single wires 11 is 0.70 or less, excessive increase in the rigidity of the belt layer 7 is suppressed, therefore, it is possible that the ride comfort performance of the tire 1 is improved.

In the cross-sectional shape of each of the steel single wires 11, it is preferred that the ratio (SD/LD) of the short diameter SD and the long diameter LD is 0.50 or more. Since the ratio (SD/LD) of the steel single wires 11 is 0.50 or more, it is possible that the length of the short diameter SD is increased, and as a result, the strength of the steel single wires 11 is maintained, thereby, it is possible that the durability performance of the tire 1 is improved.

The belt cords 10 include first belt cords 10A in which the short diameter direction of the steel single wires 11 is inclined to a first side with respective to the thickness direction of the belt ply 9, for example. It is preferred that the belt cords 10 further include second belt cords 10B in which the short diameter direction of the steel single wires 11 is inclined to a second side opposite to the first side with respective to the thickness direction of the belt ply 9. In the belt plies 9 configured as such, the direction of stress associated with the inclination of steel single wires 11 is equalized, therefore, it is possible that the steering stability performance in the tire axial direction is improved.

The second belt cords 10B of the present embodiment are inclined to the opposite side to the first belt cords 10A at the same angle θ as the first belt cords 10A. In other words, the steel single wires 11 of the first belt cords 10A and the steel single wires 11 of the second belt cords 10B are inclined in opposite sides with the same angle θ.

In the case in which the angle θ is different for each of the steel single wires 11, it is preferred that the average value of the angles θ of the steel single wires 11 in the first belt cords 10A and the average value of the angles θ of the steel single wires 11 in the second belt cords 10B are substantially equal. It is possible that the belt cords 10 configured as such further improve the steering stability performance in the tire axial direction.

It is preferred that the topping rubber 12 has a complex elastic modulus (E*) at 70° C. in the range of 7 to 20 MPa. Since the complex elastic modulus (E*) of the topping rubber 12 is 7 MPa or more, the distortion of the topping rubber 12 is suppressed, therefore, it is possible that the durability performance of the tire 1 is improved. Since the complex elastic modulus (E*) of the topping rubber 12 is 20 MPa or less, excessive increase in the rigidity of the belt layer 7 is suppressed, therefore, it is possible that the ride comfort performance of the tire 1 is improved.

Here, the complex elastic modulus (E*) at 70° C. of the topping rubber 12 was measured in accordance with Japanese Industrial Standard JIS-K6394 under the following conditions by using a dynamic viscoelasticity measurement device (EPLEXOR series) manufactured by GABO QUALIMETER Testanlagen GmbH.
Initial strain: 10%
Amplitude of dynamic strain: ±1%
Frequency: 10 Hz
Deformation mode: tensile
Measurement temperature: 70° C.

The rubber composition of the topping rubber 12 is not particularly limited in its formulation as long as the complex elastic modulus (E*) is within the above range. The rubber components used in the topping rubber 12 include, for example, natural rubber (NR), isoprene-based rubber such as isoprene rubber (IR), and diene-based rubber such as butadiene rubber (BR), styrene-butadiene rubber (SBR), styrene-isoprene-butadiene rubber (SIBR), chloroprene rubber (CR), acrylonitrile butadiene rubber (NBR) and the like. As the rubber component of the topping rubber 12, natural rubber (NR) or natural rubber (NR) combined with isoprene rubber (IR) is preferred from the point of view of the durability performance.

The topping rubber 12 may contain additional cobalt organic acid salts, for example. The cobalt organic acid salts include, for example, cobalt stearate, cobalt naphthenate, cobalt neodecanoate, cobalt boron tri-neodecanoate, and the like. The topping rubber 12 configured as such is cross-linked with belt cords 10 by cobalt elements during vulcanization molding, therefore, it is possible that the adhesion of the topping rubber 12 with the belt cords 10 is improved.

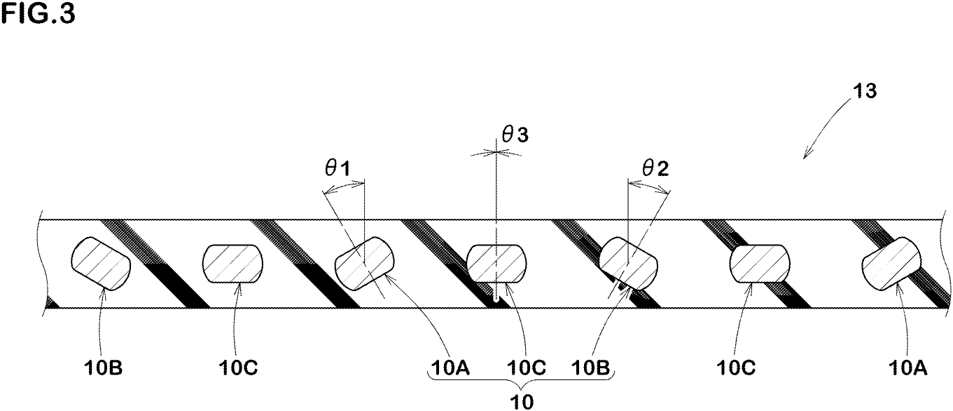

FIG. 3 is an enlarged cross-sectional view of a belt ply 13 according to another embodiment. As shown in FIG. 3, the belt cords 10 of the belt plies 13 of the present embodiment include the first belt cords 10A, the second belt cords 10B, and third belt cords 10C in which the short diameter direction of the steel single wires 11 is oriented along the thickness direction of the belt ply 9.

In the first belt cords 10A of the present embodiment, the short diameter direction of the steel single wires 11 is inclined to the first side at a first angle θ1 of less than 90 degrees with respect to the thickness direction of the belt plies 9. Further, in the second belt cords 10B, the short diameter direction of the steel single wires 11 is inclined to the second side at a second angle θ2 of less than 90 degrees with respect to the thickness direction of the belt plies 9.

In the third belt cords 10C, it is preferred that the short diameter direction of the steel single wires 11 is inclined at a third angle θ3 of within ±5 degrees with respect to the thickness direction of the belt plies 9. The belt plies 13 configured as such have a good-balanced bending rigidity, therefore, it is possible that the steering stability performance, the ride comfort performance, and the durability performance of the tire 1 are improved in a good balance.

In the present embodiment, the first angle θ1 of the first belt cords 10A and the second angle θ2 of the second belt cords 10B are substantially equal. If the number of the first belt cords 10A is equal to the number of the second belt cords 10B, it is preferred that the average value of the first angles θ1 is at least equal to the average value of the second angles θ2. It is possible that the belt plies 13 including the belt cords 10 configured as such further improve the steering stability performance in the tire axial direction.

As shown in FIGS. 2 and 3, it is preferred that five belt cords 10 adjacent in the tire axial direction include at least one first belt cord 10A and at least one second belt cord 10B. The belt plies 9 and 13 including the belt cords 10 configured as such help to improve the steering stability performance, the ride comfort performance, and the durability performance of the tire 1 in a good balance.

While detailed description has been made of an especially preferred embodiment of the present invention, the present invention can be embodied in various forms without being limited to the illustrated embodiments.

### EXAMPLES

Tires having the tire meridian cross section shown in FIG. 1 were made by way of test according to the specifications listed in Tables 1 and 2. The test tires were evaluated for the steering stability performance, the ride comfort performance, and the durability performance. The common specifications and test methods for the test tire are as follows.

### Common Specification

Test vehicle: front wheel drive mid-size passenger car

Tire size: 195/65R15

Tire inner pressure: 230 kPa

### Steering Stability Performance

While a test driver alone drove the test vehicle with the test tires mounted on all wheels thereof on a test course, the test driver evaluated the steering stability performance by the test driver’s feeling. The results are indicated by an index based on Reference 1 being 100, wherein a larger numerical value shows better steering stability performance.

### Ride Comfort Performance

While the test driver alone drove the test vehicle with the test tires mounted on all wheels thereof on the test course, the test driver evaluated the ride comfort performance by the test driver’s feeling. The results are indicated by an index based on Reference 1 being 100, wherein a larger numerical value shows better ride comfort performance.

### Durability Performance

The test tires were mounted on a bench durability testing machine and the running distance until the tires were damaged was measured. The results are indicated by an index based on Reference 1 being 100, wherein the larger the numerical value, the longer the running distance is, which shows better durability performance.

### Overall Evaluation

As an overall evaluation of the steering stability performance, the ride comfort performance, and the durability performance, the average values of the steering stability performance, the ride comfort performance, and the durability performance were calculated. The results are indicated by an index based on Reference 1 being 100, wherein a larger numerical value shows that the steering stability performance, the ride comfort performance, and the durability performance are improved in a better balance.

The test results are shown in Table 1 and Table 2.

TABLE 1

| | Ref.1 | Ref.2 | Ex.1 | Ex.2 | Ex.3 | Ex.4 | Ex.5 | Ex.6 | Ex.7 | Ex.8 |
|---|---|---|---|---|---|---|---|---|---|---|
| Arrangement of Belt cords | - | - | FIG. 2 | FIG. 2 | FIG. 2 | FIG. 2 | FIG. 2 | FIG. 2 | FIG. 2 | FIG. 2 |
| Angle θ of Belt cord [degree] | - | 0 | 5 | 10 | 15 | 20 | 25 | 30 | 35 | 40 |
| Ratio (SD/LD) of Short diameter SD and Long diameter LD of Steel single wire | 1 | 0.60 | 0.60 | 0.60 | 0.60 | 0.60 | 0.60 | 0.60 | 0.60 | 0.60 |
| Short diameter SD of Steel single wire [mm] | 0.42 | 0.30 | 0.30 | 0.30 | 0.30 | 0.30 | 0.30 | 0.30 | 0.30 | 0.30 |
| Complex elastic modulus (E*) of Topping rubber [MPa] | 12 | 12 | 12 | 12 | 12 | 12 | 12 | 12 | 12 | 12 |
| Steering stability performance [index] | 100 | 101 | 101 | 100 | 99 | 99 | 98 | 98 | 97 | 95 |
| Ride comfort performance [index] | 100 | 114 | 113 | 113 | 111 | 109 | 108 | 105 | 102 | 101 |
| Durability performance [index] | 100 | 95 | 100 | 104 | 107 | 108 | 109 | 111 | 113 | 115 |
| Overall evaluation [index] | 100 | 103 | 105 | 106 | 106 | 105 | 105 | 105 | 104 | 104 |

TABLE 2

| | Ex.9 | Ex.10 | Ex.11 | Ex.12 | Ex.13 | Ex.14 | Ex.15 | Ex.16 | Ex.17 | Ex.18 |
|---|---|---|---|---|---|---|---|---|---|---|
| Arrangement of Belt cords | FIG. 2 | FIG. 2 | FIG. 2 | FIG. 2 | FIG. 2 | FIG. 2 | FIG. 2 | FIG. 2 | FIG. 3 | FIG. 3 |
| Angle θ of Belt cord [degree] | 45 | 50 | 15 | 15 | 15 | 15 | 15 | 15 | 15 | 35 |
| Ratio (SD/LD) of Short diameter SD and Long diameter LD of Steel single wire | 0.60 | 0.60 | 0.50 | 0.70 | 0.60 | 0.60 | 0.60 | 0.60 | 0.60 | 0.60 |
| Short diameter SD of Steel single wire [mm] | 0.30 | 0.30 | 0.30 | 0.30 | 0.20 | 0.40 | 0.30 | 0.30 | 0.30 | 0.30 |
| Complex elastic modulus (E*) of Topping rubber [MPa] | 12 | 12 | 12 | 12 | 12 | 12 | 5 | 22 | 12 | 12 |
| Steering stability performance [index] | 93 | 91 | 95 | 104 | 100 | 105 | 98 | 103 | 102 | 99 |
| Ride comfort performance [index] | 100 | 99 | 112 | 109 | 115 | 103 | 114 | 98 | 102 | 97 |
| Durability performance [index] | 117 | 119 | 108 | 99 | 104 | 103 | 99 | 110 | 109 | 118 |
| Overall evaluation [index] | 103 | 103 | 105 | 104 | 106 | 104 | 104 | 104 | 104 | 105 |

From the test results, it was confirmed that the tires in Examples were capable of improving the steering stability performance, the ride comfort performance, and the durability performance in a good balance compared with the tires in References.

Description of Reference Signs

| | |
|---|---|
| 1 | tire |
| 2 | tread portion |
| 7 | belt layer |
| 9 | belt ply |
| 10 | belt cord |
| 11 | steel single wire |

1. A tire comprising a tread portion and a belt layer disposed in the tread por tion, wherein
the belt layer includes at least one belt ply,
the belt ply includes a plurality of belt cords including a steel single wire having a flat cross-sectional shape, and
in at least one of the belt cords, the steel single wire has a short diameter direction inclined at an angle of less than 90 degrees with respect to a thickness direction of the belt ply.

2. The tire according to claim 1, wherein the belt cords are inclined at an angle of 5 to 45 degrees.

3. The tire according to claim 1, wherein the belt cords are inclined at an angle of 10 to 35 degrees.

4. The tire according to claim 1, wherein the steel single wire has a short diameter (SD) of 0.15 to 0.42 mm in the cross-sectional shape.

5. The tire according to claim 1, wherein the steel single wire has a ratio (SD/LD) of 0.70 or less between a short diameter (SD) and a long diameter (LD) in the cross-sectional shape.

6. The tire according to claim 1, wherein the steel single wire has a ratio (SD/LD) of 0.50 or more between a short diameter (SD) and a long diameter (LD) in the cross-sectional shape.

7. The tire according to claim 1, wherein the belt cords include a first belt cord having the steel single wire having the short diameter direction inclined to a first side with respect to the thickness direction of the belt ply and a second belt cord having the steel single wire having the short diameter direction inclined to a second side opposite to the first side with respect to the thickness direction of the belt ply.

8. The tire according to claim 7, wherein the steel single wire of the first belt cord and the steel single wire of the second belt cord are inclined at the same angle to opposite sides to each other.

9. The tire according to claim 7, wherein the belt cords further include a third belt cord having the steel single wire having the short diameter direction oriented along the thickness direction of the belt ply.

10. The tire according to claim 7, wherein five belt cords adjacent in the tire axial direction include at least one first belt cord and at least one second belt cord.

11. The tire according to claim 1, wherein
the belt ply includes a topping rubber covering the belt cords, and
the topping rubber has a complex elastic modulus (E*) at 70° C. of 7 to 20 MPa.

12. A belt layer disposed in a tread portion comprising at least one belt ply, wherein
the belt ply includes a plurality of belt cords including a steel single wire having a flat cross-sectional shape, and
in at least one of the belt cords, the steel single wire has a short diameter direction inclined at an angle of less than 90 degrees with respect to a thickness direction of the belt ply.
